(19) United States
(12) Patent Application Publication
(10) Pub. No.: US 2016/0272510 A1
(43) Pub. Date: Sep. 22, 2016

(54) Wafer Design UV Reactor

(71) Applicant: ATG R&D LIMITED, Wigan (GB)

(72) Inventor: RICHARD JOSHI, WIGAN (GB)

(73) Assignee: ATG R&D LIMITED, WIGAN (GB)

(21) Appl. No.: 14/425,019

(22) PCT Filed: Dec. 13, 2014
(86) PCT No.: PCT/IB2014/002988

§ 371 Date: Apr. 14, 2015

Related U.S. Application Data
(60) Provisional application No. 61/916,155, filed on Dec. 14, 2013.

(51) Int. Cl. C02F 1/32

(52) U.S. Cl. CPC C02F 1/325; C02F 2201/3227; C02F 2201/3225

(57) ABSTRACT

An UV reactor system that allows single or multiple flange-less reactors to be installed between the flanges of existing piping systems. Benefits include reduced installation space and lamp placement flexibility to improve UV treatment. Each reactor can be rotated, pre and post installation, to provide multiple positions for the radiation sources that are included in each reactor.

### BACKGROUND AND SUMMARY

The present invention relates generally to fluid treatment systems and specifically to UV fluid treatment systems.

The present invention replaces standard UV system designs which have heretofore consisted of a chamber body with flanges at either end for connection to cooperating flanges of existing piping systems. FIG. 4 depicts a perspective view of a prior art reactor 12 with flanges 11 having flange mounting holes 13. Such a reactor is incorporated into an existing piping system 9 such as is depicted in the various figures wherein flange 11 is aligned with flange 6 and secured with bolts (not shown).

The present invention can be generally analogized to a butterfly valve that is mounted in between flanges of a piping system, that has no flange of its own. Thus, the flanges are eliminated. Additionally, multiple reactors can be cascaded with their lamp axis rotated about a longitudinal reactor axis, with respect to each other. Reactor mounting holes are aligned with the flange mounting holes of the existing piping system.

Such a configuration also has the advantage of allowing post-installation changes to be made without any additional hardware. Mounting bolts are removed, the reactors re-aligned, and then the mounting bolts are re-inserted.

Additional advantages of the present invention include: reduced installation space required. E.g. a 30 inch reactor is approximately 30mm wide compared to 130mm; lower fabrication (Casting possible) costs; the ability to utilize the installation piping as part of an “effective reactor”—so to speak; improved UV water treatment due to the ability to vary lamp configurations. e.g. multiple reactors can be used with lamps being rotated with respect to each other to achieve greater flexibility. Other objects and advantages will be apparent to those of skill in the art.

### BRIEF DESCRIPTION OF THE DRAWINGS

FIG. 1A depicts a perspective view of a single reactor 1 retrofitted into piping system 9 in accordance with one embodiment of the invention.

FIG. 1B depicts a perspective view of multiple reactors 1, 17 retrofitted into piping system 9 in accordance with one embodiment of the invention.

FIG. 1C depicts a perspective view of single reactor 1

FIG. 2A depicts a side view of a single reactor 1 retrofitted into piping system 9 in accordance with one embodiment of the invention.

FIG. 2B depicts a side view of multiple reactors 1, 17 retrofitted into piping system 9 in accordance with one embodiment of the invention.

FIG. 3A depicts a sectional view of line A-A of FIG. 3B

FIG. 3B depicts a side view of the reactor in one embodiment

FIG. 3C depicts a front view of the reactor in one embodiment

FIG. 3D depicts a sectional view of line B-B of FIG. 3C

FIG. 3E depicts a sectional view of line C-C of FIG. 3C

FIG. 4 depicts a perspective view of a prior art reactor 12 with flanges 11 having flange mounting holes 13.

FIG. 5A depicts a frontal view of reactor 1A of an alternative embodiment of the invention.

FIG. 5B depicts a side view of reactor 1A of an alternative embodiment of the invention.

FIG. 5C depicts a perspective view of reactor 1A of an alternative embodiment of the invention.

### REFERENCE NUMERALS IN DRAWINGS

The table below lists the reference numerals employed in the figures, and identifies the element designated by each numeral.
1 reactor 1
2 lamp 2 a.k.a “light source”, “radiation source”
3 port 3
4 ancillary device 4 a.k.a. UV sensor, or wiper.
5 pipe 5
6 pipe flange 6
7 pipe flange mounting holes 7
8 pipe flange mounting bolts 8
9 piping system 9 comprising pipe 5 having pipe flange 6, pipe flange mounting holes 7, and pipe flange mounting bolts 8.
10 reactor mounting holes 10
11 flange (PRIOR ART) 11
12 reactor (PRIOR ART) 12
13 flange mounting holes (PRIOR ART) 13
14 inner reactor wall 14
15 lamp maintenance access port 15 of reactor 1
16 irradiation cavity 16
17 second reactor 17
1A reactor 1A in an alternative embodiment
2A lamps 2A in an alternative embodiment
10A reactor mounting holes 10A in an alternative embodiment
14A inner reactor wall 14A in an alternative embodiment
16A irradiation cavity 16A in an alternative embodiment
18A lamp installation ports 18A in an alternative embodiment

### DETAILED DESCRIPTION

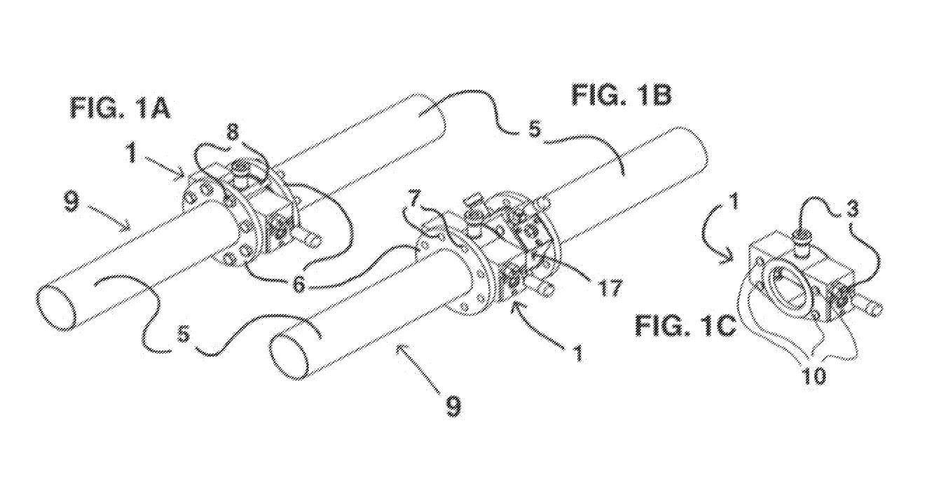

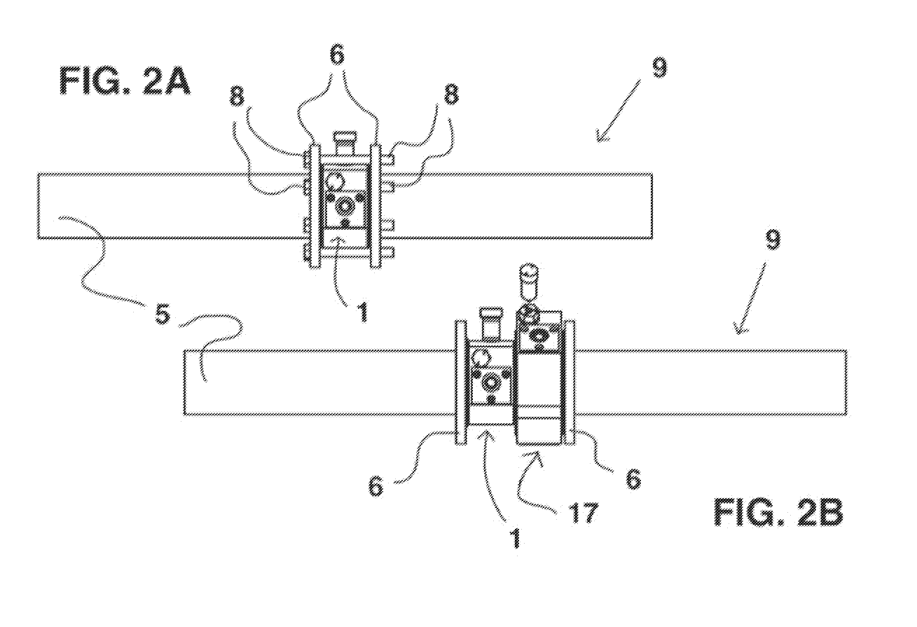

In one embodiment of the present invention, reactor 1 has, reactor mounting holes 10 adapted to be align-able (i.e. coaxial) with mounting holes 7 of a piping flange, substantially tubular irradiation cavity 16 having a longitudinal axis that is parallel to reactor mounting holes 10 and radiation source 2 (a.k.a “light source”, “radiation source”. e.g. a mercury vapor UV lamp) that is removably disposed within irradiation cavity 16; whereby the reactor can be removably secured between the flanges 6 of existing piping system 9 (e.g. FIG. 1A).

In one embodiment of the present invention, first and second reactors 1, 17 each have a plurality of mounting holes 10 adapted to be align-able with pipe flange mounting holes 7, substantially tubular irradiation cavity 16 having a longitudinal axis that is parallel to the plurality of mounting holes 10, and radiation source 2 that is removably disposed within irradiation cavity 16; whereby first and second reactors 1, 17 can be removably secured to each other, between flanges 6 of existing piping system 9, so that the irradiation cavities of the first and second reactors have a substantially common longitudinal axis; whereby the first and second reactors can be selectively arranged, relative to each other, in a plurality of positions around the substantially common longitudinal axis. In other words, the reactors can be rotated with respect to each other. This achieves at least one advantage of allowing greater flexibility to arrange lamps in various positions to alter the fluid irradiation profile.

In one embodiment, radiation source 2 is elongated (e.g. a mercury vapor UV lamp) and has a longitudinal axis that is perpendicular to the longitudinal axis of irradiation cavity 16.

FIG. 1A depicts a perspective view of a single reactor 1 retrofitted into piping system 9 in accordance with one embodiment of the invention. Pipe flange mounting bolts 8 are inserted through reactor mounting holes 10 and pipe flange mounting holes 7. Reactor mounting holes 10 are coaxial with some of pipe flange mounting holes 7. Thus, reactor 1 can be rotated with respect to piping system 9 in multiple angles according to the location of pipe flange mounting holes 7.

FIG. 1B depicts a perspective view of multiple reactors 1, 17 retrofitted into piping system 9 in accordance with one embodiment of the invention. It is to be understood that multiple reactors can be placed adjacent to each other at various angles with respect to each other and held in place by pipe flange mounting bolts 8 in conjunction with pipe flanges 6.

Reactors 1, 17 can be made of the same types of materials commonly used in conventional UV water treatment reactors, or alternatively can be made of other materials having similar strength and structural characteristics, and can be manufactured by casting or machining. The various possible manufacturing options allow for greater cost advantages to be achieved.

Fluid flows in a direction parallel to the longitudinal axis of irradiation cavity 16. In one embodiment, irradiation cavity 16 is substantially tubular. It is to be understood that such a structure facilitates efficient fluid flow characteristics in accordance with known fluid dynamics, and that other shaped cavities (e.g. ovoid) may be used in keeping with the spirit of the invention.

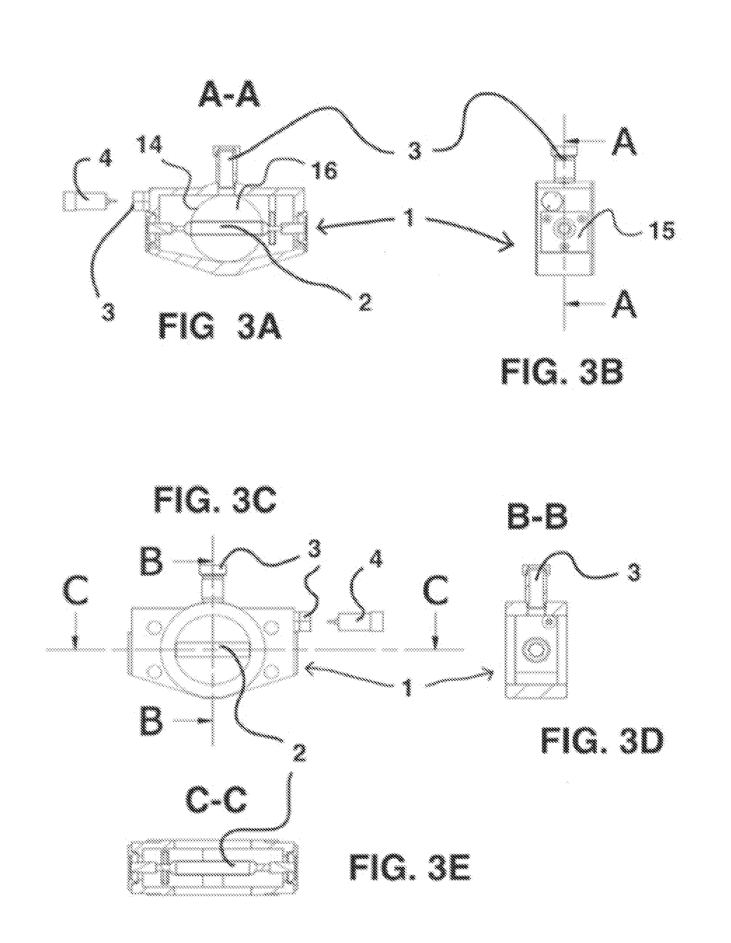

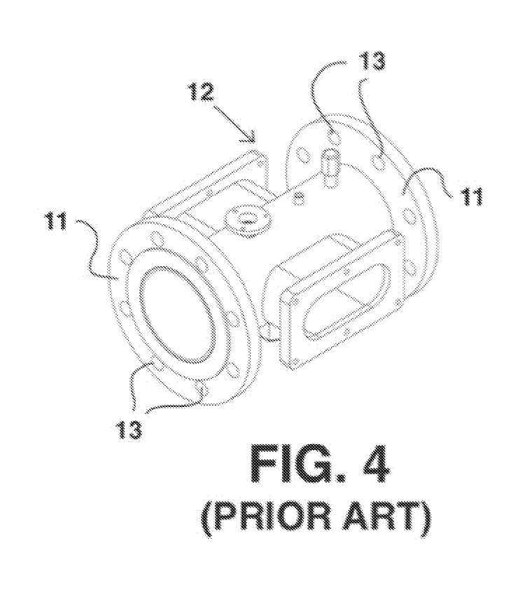

Radiation source 2 is removably disposed within irradiation cavity 16. In one embodiment (FIG. 3B), lamp maintenance access port 15 is removable to allow replacement and/or maintenance of lamp 2.

It is to be understood that the present invention can be adapted to fit different sized piping systems. In one embodiment (e.g. FIGS. 3A-3E), inner reactor wall 14 has a 4 inch diameter and a single lamp 2. However, other embodiments are possible. E.g. a 30 inch diameter and 10 lamps.

Reactor mounting holes 10 preferably extend entirely through reactor 1 to allow pipe flange mounting bolts 8 to engage pipe flange mounting holes 7 on both sides of reactor 1, or alternatively, a plurality of cascaded reactors.

In one embodiment (e.g. FIG. 1B), mounting bolts 8 are of sufficient length so as to be inserted through the coaxial reactor mounting holes 10 and pipe flange mounting holes 7. FIG. 1B depicts two reactors cascaded, but it is to be understood that more than two reactors can be cascaded. Those of skill in the art will appreciate that mounting bolts 8 would have to be sized accordingly.

In one embodiment, first and second reactors 1, 17 are of the type depicted in FIGS. 3A-3E. The irradiation cavities of the first and second reactors have a substantially common longitudinal axis that facilitates fluid (e.g. water) flow from piping system 9 through each of the reactors.

It is to be understood that ports 3 can be utilized for various purposes. E.g. in conjunction with an ancillary device 4 such as a UV sensor or wiper.

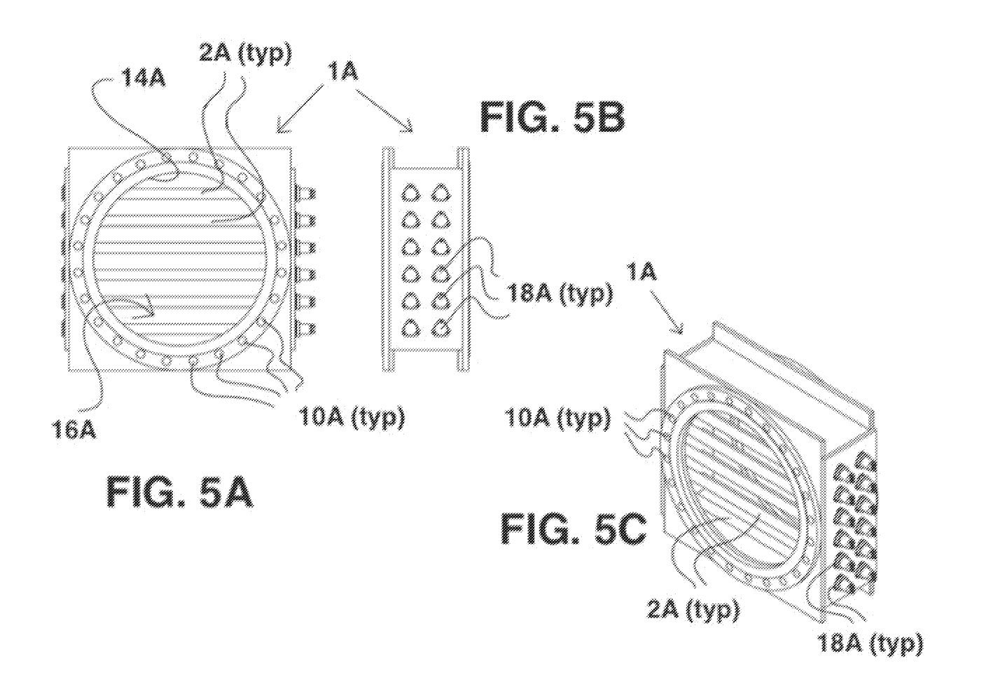

It is to be understood that various sizes of reactor 1 are possible. For example, in one embodiment (FIGS. 5A-5C), inner reactor wall 14A has a diameter of either 30 or 32 inches. Twelve lamps 2A are removably secured in lamp installation ports 18A. Reactor 1A is fabricated (i.e. not cast). Such an embodiment achieves significant space savings over conventional systems.

What is claimed is:

1. A reactor comprising:
a plurality of mounting holes adapted to be align-able with the mounting holes of a piping flange;
a substantially tubular irradiation cavity having a longitudinal axis that is parallel to the plurality of mounting holes;
and a radiation source being removably disposed within the irradiation cavity;
whereby the reactor can be removably secured between the flanges of an existing piping system.

2. The reactor of claim 1 further comprising:
the radiation source being elongated;
the longitudinal axis of the radiation source being perpendicular to the longitudinal axis of the irradiation cavity.

3. First and second reactors, each comprising:
a plurality of mounting holes adapted to be align-able with the mounting holes of a piping flange;
a substantially tubular irradiation cavity having a longitudinal axis that is parallel to the plurality of mounting holes;
a radiation source being removably disposed within the irradiation cavity;
whereby the first and second reactors can be removably secured to each other, between the flanges of an existing piping system, wherein the irradiation cavities of the first and second reactors have a substantially common longitudinal axis;
further whereby the first and second reactors can be selectively arranged, relative to each other, in a plurality of positions around the substantially common longitudinal axis.

4. The reactors of claim 3 further comprising:
the radiation source being elongated;
the longitudinal axis of the radiation source being perpendicular to the longitudinal axis of the irradiation cavity.
